(19) United States
(12) Patent Application Publication
(10) Pub. No.: US 2026/0208702 A1
(43) Pub. Date: Jul. 23, 2026

(54) SENSOR CLEANING DEVICE AND SENSOR ARRANGEMENT FOR A VEHICLE

(71) Applicant: ZF CV Systems Global GmbH, Bern (CH)

(72) Inventors: PrasadKumar Duraisamy, Chennai (IN); Adheenthran Paul Pandian, Tamil Nadu (IN)

(21) Appl. No.: 19/137,018

(22) PCT Filed: Nov. 23, 2023
(86) PCT No.: PCT/EP2023/082777

§ 371 Date: Jun. 9, 2025

(30) Foreign Application Priority Data
Dec. 9, 2022 (IN) 202211071076

(51) Int. Cl. B60S 1/56; B60S 1/52; B60S 1/54

(52) U.S. Cl. CPC B60S 1/56; B60S 1/52; B60S 1/54

(57) ABSTRACT

A sensor cleaning device (100) for cleaning a sensor device (200) of a vehicle (300a) includes an air inlet port (120) for an air flow (121), a fluid inlet port (130) for a cleaning fluid (131), an integrated outlet section (140) to eject a cleaning mixture (141) to a cover surface (201) of the sensor device (200), and a mounting section (150) to fix the sensor cleaning device (100) at the sensor device (200). The outlet section (140) includes an air outlet (142) to eject an outlet air flow (122) into an exterior environment (160) of the outlet section (140) and a fluid outlet (143) to eject the cleaning fluid (131) into the exterior environment (160). The outlet section (140) merges the cleaning fluid (131) and the outlet air flow (122) into the cleaning mixture (141) disperses the cleaning fluid (131) as fluid droplets (132).

### FIELD

The present disclosure relates to a sensor cleaning device for cleaning a sensor device of a vehicle, in particular utility vehicle, and to a sensor arrangement including a sensor device and a sensor cleaning device, and to a vehicle, in particular utility vehicle, including a sensor arrangement.

### BACKGROUND

Sensor devices, in particular optical sensor devices, such as camera devices to obtain image information and/or time-of-flight devices (e.g., based on radar, lidar and/or ultra sound) to obtain depth information, are known in the prior art. Such a sensor device typically has a cover surface which covers the sensor, electronic components and/or optics of the sensor device. However, a deposition of, for example, dirt, salt, ice and/or dust on the cover surface may deteriorate the quality of the information that is obtainable by the sensor device.

In particular for driver assistance, a safety function and/or an automated driving function of a vehicle, in particular a utility vehicle, i.e., for an automated vehicle application, surface cleaning of the cover surface, such as a camera head, is essential for a proper quality of obtained information and thus of the functioning of the intended function.

U.S. Pat. No. 6,944,908 B2 discloses a device for keeping optical elements clean in motor vehicles, especially sensor or camera covers. This is done by applying a directed stream of gas, for example a stream of air, to the transparent cover in such a way that when the cover moves relative to the surroundings no ambient atmosphere, e.g., no ambient air, reaches the surface of the cover. By using a nozzle pressurized air is blown in, producing a transverse air stream. It is also possible, using a cover, to form a buffer space in front of the cover in addition to the transverse air stream. In a further refinement, a cleaning nozzle and a heater for the cover can be provided, in order to also be able to perform cleaning when soiling has occurred during stationary operation and to remove icing at low temperatures. A design provides for at least one fluid spray nozzle for cleaning the surface of the cover.

US 2009/250533 A1 discloses a washer nozzle-equipped camera apparatus including a camera and a washer nozzle. The washer nozzle has a window spray outlet for spraying a washer fluid, supplied from a supply unit such as a pump, on a window of a vehicle. The washer nozzle further has a window duct for carrying the washer fluid to the window spray outlet. The washer nozzle further has a camera spray outlet for spraying the washer fluid on a lens of the camera. The washer nozzle further has a camera duct for carrying the washer fluid to the camera spray outlet.

### SUMMARY

It is an object of the present disclosure to provide a technological contribution and to improve at least one aspect of the prior art. An embodiment of the present disclosure may solve to object to provide a reliable and efficient cleaning of a sensor surface.

The object is solved by the subject-matter according to aspects of the present disclosure and the preferred embodiments.

According to an aspect of the present disclosure, a sensor cleaning device for cleaning a sensor device of a vehicle, in particular utility vehicle, is provided. Therein, the sensor cleaning device includes an air inlet port adapted to receive an air flow, a fluid inlet port adapted to receive a cleaning fluid, an integrated outlet section adapted to eject a cleaning mixture to a cover surface of the sensor device and a mounting section to fix the sensor cleaning device relative to the sensor device; the outlet section includes an air outlet being adapted to eject an outlet air flow into an exterior environment of the outlet section and a fluid outlet being adapted to eject the cleaning fluid into the exterior; and the outlet section is adapted to merge, in the exterior environment of the outlet section, the cleaning fluid and the outlet air flow into the cleaning mixture and to disperse the cleaning fluid as fluid droplets in the outlet air flow.

The air inlet port of the sensor device is adapted to receive pressurized air, which may stream as the air flow through the sensor cleaning device from the air inlet port to the integrated outlet section. The fluid inlet port of the sensor device is adapted to receive a cleaning fluid which may include water and/or a detergent and which may stream as the cleaning fluid through the sensor cleaning device from the fluid inlet port to the integrated outlet section.

The integrated outlet section provides an outlet to eject the cleaning mixture. The cleaning mixture is a mixture of air and the cleaning fluid. The air and the cleaning fluid, each of which is led through the sensor device, are released, i.e., ejected, from the sensor device at the outlet section into an exterior environment of the outlet section and thus into an exterior environment of the sensor device. Therein, air is ejected from the air outlet and the cleaning fluid is ejected from the fluid outlet. Thus, the outlet section is adapted to merge the cleaning fluid and the outlet air flow into the cleaning mixture, wherein merging the cleaning fluid and the outlet air flow is achieved in the exterior environment of the outlet section.

The outlet section is adapted to merge the cleaning fluid and the outlet air flow so that the flow of pressurized air induces a dispersion of the cleaning fluid into fluid droplets. Therein, the fluid droplets are dispersed in the outlet air flow. Thus, the cleaning mixture includes the outlet air flow and fluid droplets of the cleaning fluid which are dispersed in the outlet air flow. The cleaning mixture is applicable to the cover surface of the sensor device. To eject the cleaning mixture towards the cover surface, the sensor device includes a mounting section to mechanically fix the sensor cleaning device at the sensor device.

Therein, it was realized that merging the air flow and the cleaning fluid in the exterior environment of the outlet section improves the merging of the air flow and the cleaning fluid into the cleaning mixture. In particular, achieving the cleaning mixture in the exterior environment improves the dispersion of fluid droplets in the air flow. Thus, the cleaning mixture is created based an “atomizing” principle of air and water for cleaning. With the cleaning mixture being a dispersion, cleaning may be achieved with a lower water consumption compared to spraying water as a jet on the cover surface. The amount of cleaning fluid may be limited and the amount of air be adapted so that the cover surface may be dry at an end of a cleaning cycle. Thus, cleaning the cover surface with the cleaning mixture being ejected from the proposed sensor cleaning device makes cleaning the cover surface more reliable and efficient.

Preferably, the outlet section defines an ejection direction and a circumferential direction, and the fluid outlet is, in the circumferential direction, at least partially enclosed by the air outlet. This embodiment may improve merging the outlet air flow and the cleaning fluid into the cleaning mixture. By enclosing, i.e., surrounding, the fluid outlet by the air outlet, the cleaning fluid is enclosed, i.e., surrounded, by the outlet air flow circumferentially which improves and interaction between the cleaning fluid and the air in order to disperse the fluid droplets in the air flow. Preferably, the fluid outlet is, in the circumferential direction, entirely enclosed by the air outlet to maximize the interaction between the cleaning fluid and the air.

Preferably, the air outlet and the fluid outlet are arranged concentrically with respect to an ejection direction. This embodiment achieves an efficient arrangement of the air outlet and fluid outlet and may facilitate mixing the cleaning fluid and the air. Therein, the air outlet and the fluid outlet have a common center with respect to which the air outlet and the fluid outlet are arranged concentrically.

Preferably, the outlet section has a center and the fluid outlet is arranged at the center and/or between the center and the air outlet. This embodiment may improve merging the air flow and the cleaning fluid into the cleaning mixture. Thus, perpendicular to the ejection direction, the fluid outlet is arranged to be surrounded by the outlet so that cleaning fluid and air may efficiently interact with each other to disperse droplets of the cleaning fluid in the outlet air flow.

Preferably, the outlet section has an oval cross-section with a first length and a second length, wherein the first length is larger than the second length. This embodiment may provide a preferred ejection of the cleaning fluid and air, and thus a preferred application of the cleaning mixture onto the cover surface of the sensor device. Furthermore, this embodiment may improve merging the air flow and the cleaning fluid into the cleaning mixture since the oval cross section may enlarge an area in which the air flow and the cleaning fluid may interact with each other to disperse the fluid droplets in the air flow.

Preferably, the sensor cleaning device is orientable so that the first length is arranged parallel to the cover surface of the sensor device. This embodiment may provide a preferred application of the cleaning fluid onto the cover surface of the sensor device. Therein, the flow of the cleaning mixture may cover a larger area parallel to the first length than parallel to the second length.

Preferably, the fluid outlet has an oval cross-section with a first length and a second length, and the air outlet includes one or more fluid outlet sections being surrounded by the air outlet. Therein, it was realized that more than one fluid outlet sections may be provided to provide a certain amount of cleaning fluid while achieving improved distribution of the cleaning fluid. This may improve water consumption and improve the dispersion of droplets in the air flow.

Preferably, the outlet section includes one, two or three outlet ports, wherein each of the outlet ports is adapted to eject the cleaning mixture. Therein, each of the outlet ports may include the technical features of the outlet section as described above. Thus, the outlet section is divided in a plurality of outlet ports, wherein each of the outlet ports is adapted to eject the cleaning mixture as described above. By dividing the outlet section into the plurality of outlet ports the coverage of an application of the cleaning mixture onto the cover surface may be improved. Optionally, the outlet section includes more than three outlet ports to further improve the distribution of the cleaning mixture. This may enable to that a larger surface area is to be cleaned, e.g., of a dual camera head.

Preferably, the mounting section is adapted to form a snap connection and/or a bolt connection with a mounting part, wherein the mounting part is mountable to and/or comprised by a sensor housing of the sensor device. This embodiment may achieve that the sensor cleaning device, may be retro-fittable, i.e., that the cleaning device, may be mounted to already existing sensor devices. The snap connection and/or the bolt connection may provide a reversible mounting of the sensor cleaning device at the sensor device. In particular, the bolt connection may enable changing the orientation of the outlet section relative to the cover surface of the sensor device. The mounting part may be part of a sensor housing and/or may be mounted at the sensor housing, e.g., by gluing the mounting section to the sensor housing.

According to another aspect of the present disclosure, a sensor arrangement including a sensor device with a cover surface and a sensor cleaning device as described above is provided. Therein, the sensor cleaning device is fixed at the sensor device so that the cleaning mixture is applicable to the cover surface of the sensor device. The sensor cleaning device may include one or more of the optional and/or preferred features as described above to achieve a technical effect that corresponds thereto.

According to another aspect of the present disclosure, a vehicle, in particular a utility vehicle, is provided. The vehicle, in particular utility vehicle, includes the sensor arrangement as described above. The sensor cleaning device of the sensor arrangement may include one or more of the optional and/or preferred features as described above to achieve a technical effect that corresponds thereto.

### BRIEF DESCRIPTION OF THE DRAWINGS

Further advantages and technical features and their technical effects are disclosed in the figures and the description thereof.

The figures show preferred embodiments as follows:

FIG. 1 is a schematic view of a vehicle, in particular a utility vehicle, according to an embodiment of the present disclosure;

FIG. 2 is a perspective view of a sensor arrangement according to an embodiment of the present disclosure;

FIG. 3 is a perspective view of a sensor arrangement according to an embodiment of the present disclosure;

FIG. 4 is a side view of a sensor arrangement and two side views of a sensor cleaning device according to an embodiment of the present disclosure;

FIG. 5 is a side view of a sensor arrangement and a side view of a sensor cleaning device according to an embodiment of the present disclosure;

FIG. 6 is a frontal view of an outlet section of a sensor cleaning device according to an embodiment of the present disclosure;

FIG. 7 is a frontal view of an outlet section of a sensor cleaning device according to an embodiment of the present disclosure;

FIG. 8 is a section of a sensor cleaning device according to an embodiment of the present disclosure;

FIG. 9 is a top view of a sensor arrangement according to an embodiment of the present disclosure;

FIG. 10 is a section of a sensor cleaning device according to an embodiment of the present disclosure;

FIG. 11 is a section of a sensor cleaning device according to an embodiment of the present disclosure;

FIG. 12 is a top view of a sensor arrangement according to an embodiment of the present disclosure; and

FIG. 13 is a section of a sensor cleaning device according to an embodiment of the present disclosure.

### DETAILED DESCRIPTION

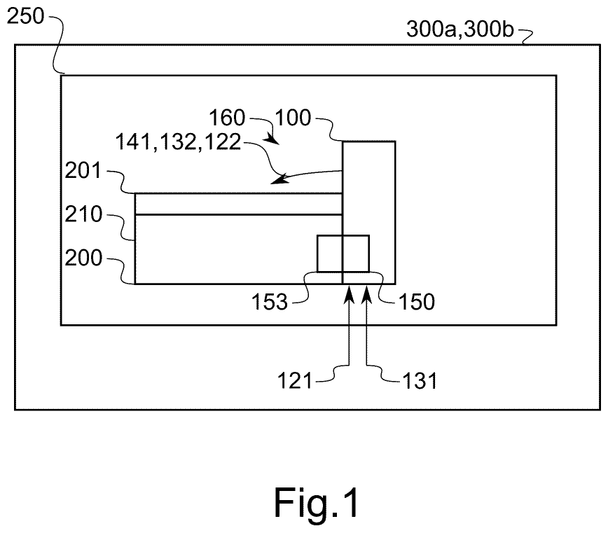

FIG. 1 shows a schematic view of a vehicle 300a, in particular a utility vehicle 300b, according to an embodiment of the present disclosure. In the following, the vehicle 300a, in particular a utility vehicle 300b, is referred to as vehicle 300a, 300b. The vehicle 300a, 300b is a motor vehicle and/or a land vehicle.

The vehicle 300a, 300b includes a sensor arrangement 250. The sensor arrangement 250 is adapted to acquire sensor data relating to an environment of the vehicle 300a, 300b. The sensor arrangement includes a sensor device 200 and a sensor cleaning device 100.

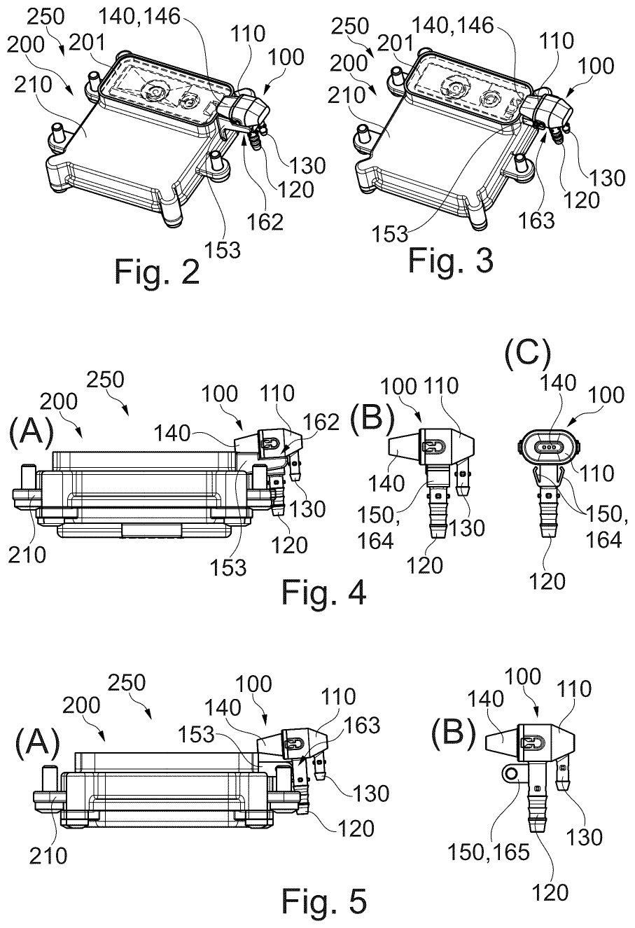

The sensor device 200 includes a sensor housing 210 to house and a cover surface 201 to cover optical, electro-mechanical and/or electronic components of the sensor device 200. The sensor device 200 includes a mounting part 153, or a mounting part 153 is mountable the sensor housing 210 (see, e.g., FIGS. 2 to 5).

The sensor cleaning device 100 includes a mounting section 150 which is mounted to the mounting part 153. Thus, the sensor cleaning device 100 is mounted to the sensor device 200. The sensor cleaning device 100 receives an air flow 121 and a cleaning fluid 131 and ejects a cleaning mixture 141, including an outlet air flow 122 and fluid droplets 132 being dispersed in the outlet air flow 122, into an exterior environment 160 of the sensor cleaning device 100 and onto the cover surface 201. Individual flow of air 121 and of cleaning fluid 131 is given based on the nature of the debris and/or pollutants.

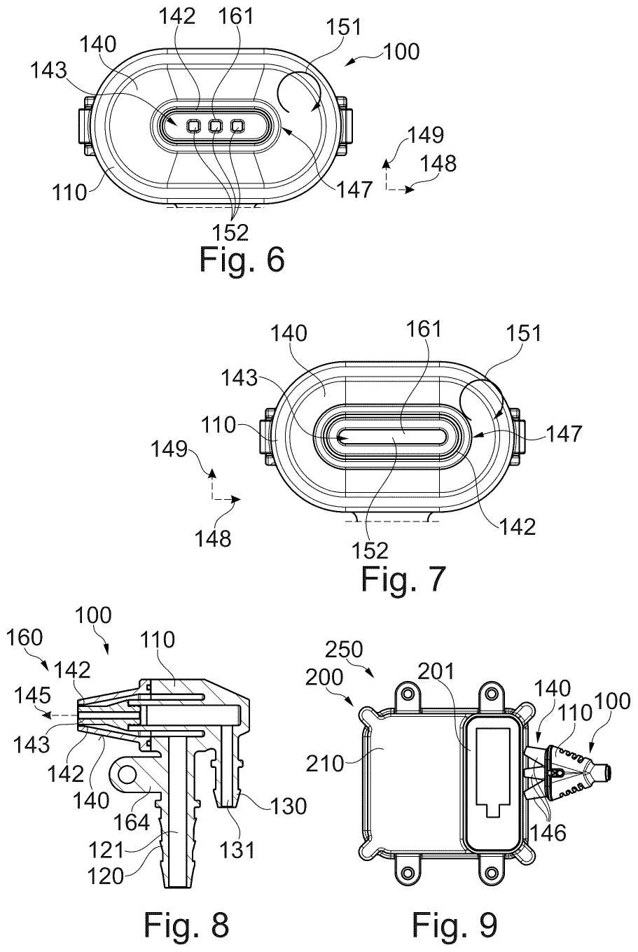

The sensor cleaning device 100 makes use of a side mounted nozzle which dispenses air 122 and cleaning fluid 131 as a cleaning mixture 141. This nozzle has two outlets 120, 130, i.e., one for air 122 and one for the cleaning fluid 131 and incorporates an atomizing principle of air 122 and the cleaning fluid 131 to dispense fluid droplets 132 in the outlet air flow 122 (see in particular FIGS. 6 and 7). The sensor cleaning device 100, i.e., the nozzle, uses air 122 and cleaning fluid 131 to clean the cover surface 201. The nozzle includes separate inlets for air and cleaning fluid and is mounted to the sensor device 200 in such a way that a field of view of the sensor is not obstructed.

The sensor arrangement 250 and the sensor cleaning device 100 are further described with reference to FIGS. 2 to 13.

FIG. 2 shows a perspective view of a sensor arrangement 250 according to an embodiment of the present disclosure. The sensor arrangement 250 of FIG. 2 is described under reference to FIG. 1 and the description thereof.

The sensor device 200 includes the sensor housing 210 and the cover surface 201. The cover surface 201 covers schematically illustrated optical components (not indicated). The sensor cleaning device 100 is adapted to clean the sensor device 200 and in particular the cover surface 201.

The sensor cleaning device 100 includes a housing 110. The housing 110 may be made of and/or include plastics to enable an efficient manufacture and provide a light-weight housing. The sensor cleaning device 100 includes an air inlet port 120 adapted to receive an air flow 121, a fluid inlet port 130 adapted to receive a cleaning fluid 131, an integrated outlet section 140 adapted to eject a cleaning mixture 141 to the cover surface 201 of the sensor device 200. The air inlet port 120, the fluid inlet port 130 and the outlet section 140 are integrally formed by the housing 110.

The air inlet port 120 is adapted to be connected to an air supply (not shown) which may provide the air flow 121 by an application of pressurized air. The fluid inlet port 130 is adapted to be connected to a cleaning fluid supply (not shown) which may provide the cleaning fluid 131.

The outlet section 140 has an oval cross-section 147 with a first length 148 (which may also be referred to as a first extension) and a second length 149 (which may also be referred to as a first extension), wherein the first length 148 is larger than the second length 149 (see also FIGS. 6 and 7). The sensor cleaning device 100 is oriented so that the first length 148 is arranged parallel to the cover surface 201 of the sensor device 200. The outlet section 140 has one port 146 being adapted to eject the cleaning mixture 141.

The sensor cleaning device 100 includes a mounting section 150 to fix the sensor cleaning device 100 at the sensor device 200, specifically to a mounting part 153 that is mounted to the sensor housing 210. Therein, the mounting section 150 is adapted to form a snap connection 162 as further described with reference to FIG. 4.

FIG. 3 shows a perspective view of a sensor arrangement 250 according to an embodiment of the present disclosure. The sensor arrangement 250 of FIG. 3 is described under reference to FIG. 2 and the description thereof. Therein, differences between the sensor arrangement 250 of FIG. 2 and the sensor arrangement 250 of FIG. 3 are described.

In the embodiment of FIG. 3, the mounting section 150 is adapted to form a bolt connection 163 as further described with reference to FIG. 5.

FIG. 4 shows a side view of a sensor arrangement 250 (FIG. 4(A)) and two side views (FIGS. 4(B) and 4(C)) of a sensor cleaning device 100 according to an embodiment of the present disclosure. The sensor arrangement 250 is the sensor arrangement 250 as shown in FIG. 2 and described under reference thereto.

As shown in FIG. 4(A), the mounting part 153 is adapted to form the snap connection 162. The mounting part 153 is integrally formed with the sensor housing 210, or the mounting part 153 is separate from the sensor housing 210 and may be mounted to the sensor housing 210, e.g., by a gluing connection.

As shown in FIGS. 4(B) and (C), the sensor cleaning device 100 includes a mounting section 150 that is formed by two snap connectors 164. The snap connectors 164 are adapted to form the snap connection 162 with the mounting part 153. The snap connectors 164 are integrally formed by the housing 110 of the sensor cleaning device 100. The snap connectors 164 may be elastically deformed to be arranged in a recess and/or a hole of the mounting part 153 to optionally reversibly mount the sensor cleaning device 100 at the mounting part 153.

FIG. 5 shows a side view of a sensor arrangement 250 (FIG. 5(A)) and a side view (FIG. 5(B)) side view of a sensor cleaning device 100 according to an embodiment of the present disclosure. The sensor arrangement 250 is the sensor arrangement 250 as shown in FIG. 3 and described under reference thereto.

As shown in FIG. 5(A), the mounting part 153 is adapted to form the bolt connection 163. The mounting part 153 is integrally formed with the sensor housing 210, or the mounting part 153 is separate from the sensor housing 210 and may be mounted to the sensor housing 210, e.g., by a gluing connection.

As shown in FIG. 5(B), the sensor cleaning device 100 includes a mounting section 150 that is formed by a bolt connector 165. The bolt connector 165 is adapted to form the bolt connection 163 with the mounting part 153, e.g., the bolt connector 165 includes a through hole as shown in FIG. 5(B) and a bolt may be arranged in the through hole and may be fixed at the mounting part 153. The bolt connector 165 is integrally formed by the housing 110 of the sensor cleaning device 100. The bolt connection 163 enables a pivoting around an axis as being defined by the bolt (not shown) to adjust an ejection direction 145 of the sensor cleaning device 100 (see, e.g., FIGS. 8, 10, 11 and 13).

FIG. 6 shows a frontal view of an outlet section 140 of a sensor cleaning device 100 according to an embodiment of the present disclosure. Such a sensor cleaning device is described with reference to FIGS. 1 to 5.

The outlet section 140 includes an air outlet 142 being adapted to eject the outlet air flow 122 into the exterior environment 160 of the outlet section 140 and a fluid outlet 143 being adapted to eject the cleaning fluid 131 into the exterior environment 160. The outlet section 140 defines an ejection direction 145 (not shown in the Figure, see FIGS. 8, 10, 11 and 13) that is oriented out of the drawing plane and a circumferential direction 151 as schematically indicated by an arrow with a solid line. The fluid outlet 143 is, in the circumferential direction 151, entirely enclosed by the air outlet 142. The air outlet 142 and the fluid outlet 143 are arranged concentrically with respect to the ejection direction 145.

The outlet section 140 includes a center 161 and the fluid outlet 143 is arranged at the center 161 and between the center 161 and the air outlet 142. The fluid outlet 143 includes an oval cross-section 147 with a first length 148 and a second length 149. I.e., the outlet section 140 includes a slot opening to enable cleaning a large surface area without any complexity in nozzle design.

The fluid outlet 143 includes a plurality of fluid outlet sections 152 being surrounded by the air outlet 142. Therein, the outlet section 140 is adapted to merge, in the exterior environment 160 of the outlet section 140, the cleaning fluid 131 and the outlet air flow 122 into the cleaning mixture 141 and to disperse the cleaning fluid 131 into fluid droplets 132 in the outlet air flow 122.

FIG. 7 shows a frontal view of an outlet section 140 of a sensor cleaning device 100 according to an embodiment of the present disclosure. The sensor cleaning device 100 of FIG. 7 is described under reference to FIG. 6 and the description thereof. Therein, differences between the sensor cleaning device 100 of FIG. 6 and the sensor cleaning device 100 of FIG. 7 are described.

The fluid outlet 143 has an oval cross-section 147 with a first length 148 and a second length 149, and the fluid outlet 143 includes a single fluid outlet section 152 being surrounded by the air outlet 142. Therein, the cross-sectional area of the single fluid outlet section 152 of FIG. 7 is larger than each of the cross-sectional areas of the plurality of the fluid outlet sections 152 of FIG. 6. In this embodiment, the cross-sectional area of the single fluid outlet section 152 of FIG. 7 is larger than the sum of the cross-sectional areas of the plurality of the fluid outlet sections 152 of FIG. 6. Thus, the cleaning fluid consumption of the sensor cleaning device 100 of FIG. 6 may be lower than the cleaning fluid consumption of the sensor cleaning device 100 of FIG. 7, and the dispersion of fluid droplets 132 of the sensor cleaning device 100 of FIG. 6 may be improved.

FIG. 8 shows a section of a sensor cleaning device 100 according to an embodiment of the present disclosure. Such a sensor cleaning device is described with reference to FIGS. 1 to 7.

The section of the sensor cleaning device 100 illustrates the concentric arrangement of the air outlet 142 and the fluid outlet 143 with respect to the ejection direction 145. Therein, the fluid outlet 143 is, in the circumferential direction 151, enclosed by the air outlet 142.

FIG. 9 shows a top view of a sensor arrangement 250 according to an embodiment of the present disclosure. The sensor arrangement 250 of FIG. 9 is described under reference to the foregoing Figures and the description thereof. Therein, differences between the sensor arrangement 250 of FIG. 9 and the sensor arrangements 250 of foregoing Figures are described.

The outlet section 140 includes three outlet ports 146, wherein each of the outlet ports 146 is adapted to eject the cleaning mixture 141 in particular as described with reference to FIGS. 6 and 7.

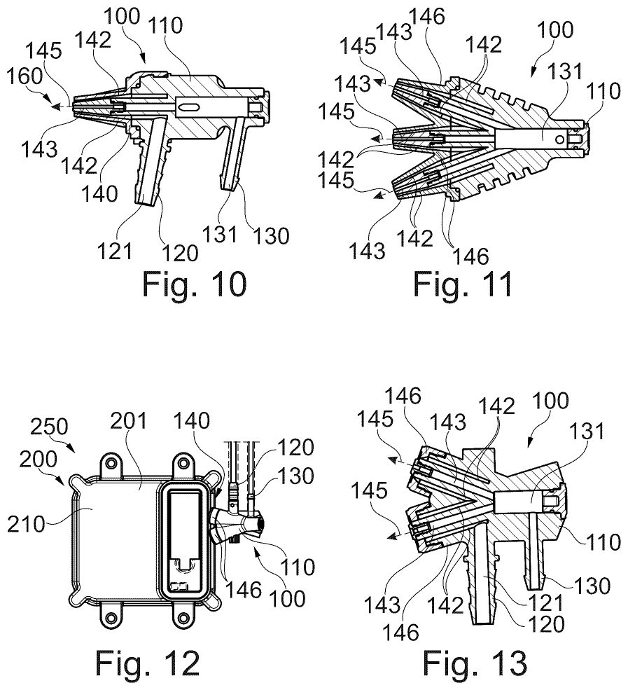

FIG. 10 shows a section of a sensor cleaning device 100 according to an embodiment of the present disclosure. The sensor cleaning device 100 is the sensor cleaning device 100 as shown in FIG. 9. FIG. 10 is described under reference to FIG. 9 and the description thereof. Therein, the section of the sensor cleaning device 100 illustrates the concentric arrangement of the air outlet 142 and the fluid outlet 143 with respect to the ejection direction 145. Therein, the fluid outlet 143 is, in the circumferential direction, enclosed by the air outlet 142.

FIG. 11 shows a section of a sensor cleaning device 100 according to an embodiment of the present disclosure. The sensor cleaning device 100 is the sensor cleaning device 100 as shown in FIGS. 9 and 10. FIG. 11 is described under reference to FIGS. 9 and 10 and the description thereof.

The outlet section 140 includes three outlet ports 146, wherein each of the outlet ports 146 is adapted to eject the cleaning mixture 141 in particular as described with reference to FIGS. 6 and 7. In particular, at each of the outlet ports 164, the air outlet 142 and the fluid outlet 143 are concentrically arranged with respect to the ejection direction 145. Therein, the fluid outlet 143 is, in the circumferential direction, enclosed by the air outlet 142.

FIG. 12 shows a top view of a sensor arrangement 250 according to an embodiment of the present disclosure. The sensor arrangement 250 of FIG. 12 is described under reference to the FIG. 9 and the description thereof. Therein, differences between the sensor arrangement 250 of FIG. 12 and the sensor arrangement 250 of FIG. 9 are described.

The outlet section 140 includes two outlet ports 146, wherein each of the outlet ports 146 is adapted to eject the cleaning mixture 141.

FIG. 13 shows a section of a sensor cleaning device 100 according to an embodiment of the present disclosure. The sensor cleaning device 100 is the sensor cleaning device 100 as shown in FIG. 12. FIG. 13 is described under reference to FIG. 12 and the description thereof.

The outlet section 140 includes two outlet ports 146, wherein each of the outlet ports 146 is adapted to eject the cleaning mixture 141 in particular as described with reference to FIGS. 6 and 7. In particular, at each of the outlet ports 164, the air outlet 142 and the fluid outlet 143 are concentrically arranged with respect to the ejection direction 145. Therein, the fluid outlet 143 is, in the circumferential direction, enclosed by the air outlet 142.

### LIST OF REFERENCE SIGNS (PART OF THE DESCRIPTION)

100 sensor cleaning device
110 housing
120 air inlet port
121 air flow
122 outlet air flow
130 fluid inlet port
131 cleaning fluid
132 fluid droplets
140 outlet section
141 cleaning mixture
142 air outlet
143 fluid outlet
145 ejection direction
146 outlet port
147 cross-section
148 first length
149 second length
150 mounting section
151 circumferential direction
152 fluid outlet section
153 mounting part
160 exterior environment
161 center
162 snap connection
163 bolt connection
164 snap connector
165 bolt connector
200 sensor device
201 cover surface
210 sensor housing
250 sensor arrangement
300a vehicle
300b utility vehicle

1. A sensor cleaning device (100) for cleaning a sensor device (200) of a vehicle (300a, 300b), the sensor cleaning device comprising:
an air inlet port (120) configured to receive an air flow (121),
a fluid inlet port (130) configured to receive a cleaning fluid (131),
an integrated outlet section (140) configured to eject a cleaning mixture (141) to a cover surface (201) of the sensor device (200) and
a mounting section (150) configured to fix the sensor cleaning device (100) to the sensor device (200);
wherein the outlet section (140) comprises an air outlet (142) configured to eject an outlet air flow (122) into an exterior environment (160) of the outlet section (140) and a fluid outlet (143) configured to eject the cleaning fluid (131) into the exterior environment (160);
wherein the outlet section (140) is configured to merge, in the exterior environment (160) of the outlet section (140), the cleaning fluid (131) and the outlet air flow (122) into the cleaning mixture (141), and to disperse the cleaning fluid (131) as fluid droplets (132) in the outlet air flow (122).

2. The sensor cleaning device (100) as claimed in claim 1,
wherein the outlet section (140) defines an ejection direction (145) and a circumferential direction (151), and the fluid outlet (143) is, in the circumferential direction (151), at least partially enclosed by the air outlet (142).

3. The sensor cleaning device (100) as claimed in claim 1,
wherein the air outlet (142) and the fluid outlet (143) are arranged concentrically with respect to an ejection direction (145).

4. The sensor cleaning device (100) as claimed in claim 1,
wherein the outlet section (140) includes a center (161) and the fluid outlet (143) is arranged at the center (161) or between the center (161) and the air outlet (142).

5. The sensor cleaning device (100) as claimed in claim 1,
wherein the outlet section (140) has an oval cross-section (147) with a first length (148) and a second length (149) perpendicular to the first length, wherein the first length (148) is larger than the second length (149).

6. The sensor cleaning device (100) as claimed in claim 5,
wherein the sensor cleaning device (100) is oriented so that the first length extension (148) is arranged parallel to the cover surface (201) of the sensor device (200).

7. The sensor cleaning device (100) as claimed in claim 1,
wherein the fluid outlet (143) has an oval cross-section (147) with a first length (148) and a second length (149), and the fluid outlet (143) includes one or more fluid outlet sections (152) surrounded by the air outlet (142).

8. The sensor cleaning device (100) as claimed in claim 1,
wherein the outlet section (140) comprises one, two or three outlet ports (146), wherein each of the outlet ports (146) is adapted to eject the cleaning mixture (141).

9. The sensor cleaning device (100) as claimed in claim 1,
wherein the mounting section (150) is configured to form a snap connection (162) with a mounting part (153), wherein the mounting part (153) is configured to mount to a sensor housing (210) of the sensor device (200).

10. A sensor arrangement (250) comprising a sensor device (200) with a cover surface (201) and the sensor cleaning device (100) as claimed in claim 1, wherein the sensor cleaning device (100) is fixed relative to the sensor device (200) such that the cleaning mixture (141) is applied to the cover surface (201) of the sensor device (200).

11. A vehicle (300a, 300b) comprising the sensor arrangement (250) as claimed in claim 10.

12. The sensor cleaning device (100) as claimed in claim 2, wherein the fluid outlet (143) is, in the circumferential direction (151), entirely enclosed by the air outlet (142).

13. The sensor cleaning device (100) as claimed in claim 1,
wherein the mounting section (150) is configured to form a snap connection (162) with a mounting part (153), wherein the mounting part (153) is part of a sensor housing (210) of the sensor device (200).

14. The sensor cleaning device (100) as claimed in claim 1,
wherein the mounting section (150) is configured to form a bolt connection (163) with a mounting part (153), wherein the mounting part (153) is configured to mount to a sensor housing (210) of the sensor device (200).

15. The sensor cleaning device (100) as claimed in claim 1,
wherein the mounting section (150) is configured to form a bolt connection (163), wherein the mounting part (153) is part of a sensor housing (210) of the sensor device (200).
